(19) United States
(12) Patent Application Publication
(10) Pub. No.: US 2023/0207772 A1
(43) Pub. Date: Jun. 29, 2023

(54) ALL-SOLID-STATE BATTERY WITH IMPROVED INTERFACIAL PROPERTIES

(71) Applicants: HYUNDAI MOTOR COMPANY, Seoul (KR); KIA CORPORATION, Seoul (KR)

(72) Inventors: Jae Min Lim, Suwon-si (KR); Hong Suk Choi, Hwaseong-si (KR); Seon Hwa Kim, Cheongju-si (KR); Hee Soo Kang, Seoul (KR); Young Jin Nam, Suwon-si (KR); Sang Wan Kim, Anyang-si (KR)

(73) Assignees: Hyundai Motor Company, Seoul (KR); Kia Corporation, Seoul (KR)

(21) Appl. No.: 17/989,190

(22) Filed: Nov. 17, 2022

(30) Foreign Application Priority Data
Dec. 23, 2021 (KR) 10-2021-0185922

(51) Int. Cl. H01M 4/04

(52) U.S. Cl. CPC H01M 4/0404; H01M 2004/021

(57) ABSTRACT

An all-solid-state battery comprises a cathode active material layer, an anode active material layer and a solid electrolyte layer interposed between the cathode active material layer and the anode active material layer, and wherein the all-solid-state battery satisfies Requirement 1 below,

3<(b₁+b₂)/a[10⁻⁴·cm³/mA]<11, [Requirement 1]
wherein, a indicates current density [mA/cm²] of the all-solid-state battery, b₁ indicates surface roughness [μm] of one side of a cathode active material layer in a direction to a solid electrolyte layer, and b₂ indicates surface roughness [μm] of one side of an anode active material layer in a direction to the solid electrolyte layer.

### CROSS-REFERENCE TO RELATED APPLICATION

This application claims under 35 U.S.C. § 119(a) the benefit of priority to Korean Patent Application No. 10-2021-0185922 filed on Dec. 23, 2021 in the Korean Intellectual Property Office, the entire contents of which are incorporated herein by reference.

### TECHNICAL FIELD

The present disclosure relates to an all-solid-state battery with improved interfacial properties.

### BACKGROUND

An all-solid-state battery is a three-layer stack structure including a cathode active material layer provided on a cathode current collector, an anode active material layer provided on an anode current collector, and a solid electrolyte layer interposed between the cathode active material layer and the anode active material layer.

The anode active material layer of the all-solid-state battery includes a solid electrolyte conducting lithium ions, in addition to an active material, such as graphite or the like.

All components of the all-solid-state battery exist in a solid state, and thus, interfacial states between the respective layers has a great effect on cell performance. Therefore, surface roughnesses of the cathode active material layer and the anode active material layer is a very important factor which influences the interfacial states and cell performance.

In general, when interface roughness is excessively great, a lot of side reactions occur, and reaction uniformity is reduced, and therefore, interface roughness needs to be decreased. However, when interface roughness is excessively small, interlayer adhesion is reduced and causes increase in resistance. This consequently causes decline in durability and efficiency, and thus deteriorates cell performance.

Therefore, the present disclosure suggests an electrode structure which may derive optimum cell performance, and a method for designing the same.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide an all-solid-state battery having improved interfacial properties, such as interlayer adhesion, a reaction site, side reaction suppression and reaction uniformity.

In one aspect, the present disclosure provides an all-solid-state battery including a cathode active material layer, an anode active material layer, and a solid electrolyte layer interposed between the cathode active material layer and the anode active material layer, and wherein the all-solid-state battery satisfies Requirement 1 below,

3<(b₁+b₂)/a[10⁻⁴·cm³/mA]<11, [Requirement 1]

wherein a indicates current density [mA/cm²] of the all-solid-state battery, b₁ indicates surface roughness [μm] of one side of the cathode active material layer in a direction to the solid electrolyte layer, and b₂ indicates surface roughness [μm] of one side of the anode active material layer in a direction to the solid electrolyte layer.

In a preferred embodiment, the current density of the all-solid-state battery may range from about 1 mA/cm² to 5 mA/cm².

In another preferred embodiment, a ratio of the surface roughness of one side of the cathode active material layer in the direction to the solid electrolyte layer to the surface roughness of one side of the anode active material layer in the direction to the solid electrolyte layer may range from about 1/3 to 1.

In still another preferred embodiment, the all-solid-state battery may satisfy Requirement 2 below,

0.25<b₁/(b₁+b₂)<0.50. [Requirement 2]

In yet another preferred embodiment, the all-solid-state battery may satisfy Requirement 3 below,

0.50<b₂/(b₁+b₂)<0.75. [Requirement 3]

In still yet another preferred embodiment, the surface roughness of one side of the cathode active material layer in the direction to the solid electrolyte layer may range from about 4 μm to 50 μm.

In a further preferred embodiment, the surface roughness of one side of the anode active material layer in the direction to the solid electrolyte layer may range from about 4 μm to 50 μm.

In another further preferred embodiment, the cathode active material layer may include an amount of about 80% to 90% by weight of a cathode active material.

In still another further preferred embodiment, the anode active material layer may include an amount of about 70% to 90% by weight of an anode active material.

In yet another further preferred embodiment, the solid electrolyte layer may include a sulfide-based solid electrolyte having lithium ion conductivity of about 0.3 mS/cm or more.

In still yet another further preferred embodiment, a thickness of the solid electrolyte layer may range from about 30 μm to 70 μm.

In a still further preferred embodiment, the all-solid-state battery may further include a cathode current collector located on the cathode active material layer, and a thickness of the cathode current collector may range from about 6 μm to 12 μm.

In a yet still further preferred embodiment, the all-solid-state battery may further include an anode current collector located on the anode active material layer, and a thickness of the anode current collector may range from about 5 μm to 10 μm.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a cross-sectional view of an all-solid-state battery according to the present disclosure;

FIG. 2 shows a cross-sectional view of interfaces between respective layers of the all-solid-state battery according to the present disclosure;

FIG. 3A shows results of measurement of surface roughnesses of an all-solid-state battery according to Example 1;

FIG. 3B shows results of measurement of surface roughnesses of an all-solid-state battery according to Example 2;

FIG. 3C shows results of measurement of surface roughnesses of an all-solid-state battery according to Comparative Example 1;

FIG. 4 shows results of measurement of capacity retentions of the all-solid-state batteries according to Example 1, Example 2 and Comparative Example 1;

FIG. 5A shows results of measurement of surface roughnesses of an all-solid-state battery according to Example 3;

FIG. 5B shows results of measurement of surface roughnesses of an all-solid-state battery according to Example 4;

FIG. 5C shows results of measurement of surface roughnesses of an all-solid-state battery according to Comparative Example 2; and

FIG. 6 shows results of measurement of capacity retentions of the all-solid-state batteries according to Example 3, Example 4 and Comparative Example 2.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given herein below with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. Whether modified by the term “about” the claims appended hereto include equivalents to these quantities. The term “about” further may refer to a range of values that are similar to the stated reference value. In certain embodiments, the term “about” refers to a range of values that fall within 10, 9, 8, 7, 6, 5, 4, 3, 2, 1 percent above or below the numerical value (except where such number would exceed 100% of a possible value or go below 0%) or a plus/minus manufacturing/measurement tolerance of the numerical value. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

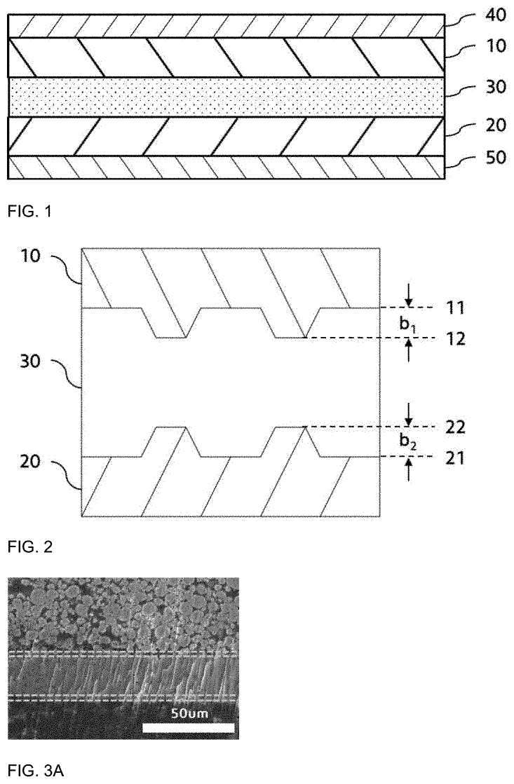

FIG. 1 shows a cross-sectional view of an all-solid-state battery according to the present disclosure. The all-solid-state battery may include a cathode active material layer 10, an anode active material layer 20, and a solid electrolyte layer 30 interposed between the cathode active material layer 10 and the anode active material layer 20. The all-solid-state battery may include a cathode current collector 40 disposed on the cathode active material layer 10, and an anode current collector 50 disposed on the anode active material layer 20.

The present disclosure is characterized in that interfacial properties between the cathode active material layer 10 and the solid electrolyte layer 30 and between the anode active material layer 20 and the solid electrolyte layer 30 are enhanced so as to improve cell performance. Specifically, inventors of the present disclosure have proved that the interfacial properties of the all-solid-state battery are influenced by current density in addition to surface roughnesses of the cathode active material layer 10 and the anode active material layer 20, and have completed the present disclosure by establishing relationships between surface roughness and current density.

In the following description of the present disclosure, interfacial properties include interfacial resistance, interlayer adhesion, a reaction site, side reaction suppression, reaction uniformity, durability with respect to volume expansion, etc.

FIG. 2 shows cross-sectional view of interfaces between the respective layers of the all-solid-state battery according to the present disclosure. Although FIG. 2 illustrates that a concave-convex structure is regularly formed on the surfaces of the cathode active material layer 10 and the anode active material layer 20 for convenience of explanation, the surfaces of the cathode active material layer 10 and the anode active material layer 20 are not limited thereto.

The meaning of the surface roughness of the cathode active material layer 10 is as follows. A roughness curve is acquired by continuously connecting contact points between the cathode active material layer 10 and the solid electrolyte layer 30 in the horizontal direction. The surface roughness of the cathode active material layer 10 means a vertical distance between one point located on the roughness curve, which is closest to the cathode active material layer 10, and another point located on the roughness curve, which protrudes closest to the solid electrolyte layer 30.

The meaning of the surface roughness of the anode active material layer 20 is as follows. A roughness curve is acquired by continuously connecting contact points between the anode active material layer 20 and the solid electrolyte layer 30 in the horizontal direction. The surface roughness of the anode active material layer 20 means a vertical distance between one point located on the roughness curve, which is closest to the anode active material layer 20, and another point located on the roughness curve, which protrudes closest to the solid electrolyte layer 30.

When the surface roughnesses of the cathode active material layer 10 and the anode active material layer 20 exceed a critical level, the contact areas between the respective layers 10 and 20 and the solid electrolyte layer 30 are increased, and thus, a lot of side reactions may occur. Further, when the surface roughnesses are increased, current is concentrated on a specific region depending on an interfacial shape, and thus, reaction may not be uniformly occur, and this may cause growth of lithium dendrites and may thereby deteriorate durability of the all-solid-state battery.

On the other hand, when the surface roughnesses of the cathode active material layer 10 and the anode active material layer 20 are less than another critical level, the contact areas between the respective layers 10 and 20 and the solid electrolyte layer 30 are decreased, and thus, conductivity of lithium ions may be reduced, and problems, such as decrease in utilization of lithium ions and increase in interfacial resistance, may occur. Further, when the physical contact areas between the respective layers 10 and 20 and the solid electrolyte layer 30 are decreased, interfacial adhesion may be reduced, and the interfaces therebetween may be damaged in case of volume expansion.

That is, when the surface roughnesses of the cathode active material layer 10 and the anode active material layer 20 are within an optimum level range, adhesion force may be increased while interfacial resistances therebetween are reduced, and lithium ions may rapidly migrate along the interfaces therebetween.

Differences in the interfacial resistances and reactivities between the cathode and anode active material layers 10 and 20 and the solid electrolyte layer 30 may be influenced not only by the above-described surface roughnesses therebetween but also by current density.

The current density means current flowing per unit area of the cross-section of the all-solid-state battery perpendicular to the stacking direction of the all-solid-state battery.

In the case in which the current density exceeds a critical level, when the surface roughnesses of the cathode active material layer 10 and the anode active material layer 20 are excessively small, a crack easily occurs due to expansion and contraction around the interfaces during charging and discharging, and thus, durability of the all-solid-state battery may be reduced.

In the case in which the current density is less than another critical level, when the surface roughnesses of the cathode active material layer 10 and the anode active material layer 20 are excessively great, a lot of side reactions rapidly occur and thus charging and discharging efficiency may be reduced, and current is concentrated on many regions and thus durability of the all-solid-state battery may be reduced.

Specifically, the all-solid-state battery may satisfy the following Requirement 1.

3<(b₁+b₂)/a[10⁻⁴·cm³/mA]<11 [Requirement 1]

Here, a indicates current density [mA/cm²] of the all-solid-state battery, b₁ indicates surface roughness [μm] of the cathode active material layer 10 with respect to the solid electrolyte layer 30, and b₂ indicates surface roughness [μm] of the anode active material layer 20 with respect to the solid electrolyte layer 30.

The current density of the all-solid-state battery may be about 1 mA/cm² to 5 mA/cm².

The surface roughnesses of the cathode active material layer 10 and the anode active material layer 20 influence the resistance of the all-solid-state battery. However, when the surface roughness b₁ of the cathode active material layer 10 is less than the surface roughness b₂ of the anode active material layer 20 having a relatively low resistance, the resistance of the all-solid-state may be further reduced.

Specifically, the ratio b₁/b₂ of the surface roughness b₁ of the cathode active material layer 10 with respect to the solid electrolyte layer 30 to the surface roughness b₂ of the anode active material layer 20 with respect to the solid electrolyte layer 30 may be about 1/3 to 1.

Further, the all-solid-state battery may satisfy the following Requirement 2.

0.25<b₁/(b₁+b₂)<0.50 [Requirement 2]

Moreover, the all-solid-state battery may satisfy the following Requirement 3.

0.50<b₂/(b₁+b₂)<0.75 [Requirement 3]

The surface roughness b₁ of the cathode active material layer 10 with respect to the solid electrolyte layer 30 may be about 4 μm to 50 μm.

The surface roughness b₂ of the anode active material layer 20 with respect to the solid electrolyte layer 30 may be about 4 μm to 50 μm.

The surface roughnesses b₁ and b₂ of the cathode active material layer 10 and the anode active material layer 20 may be implemented by pressing the surfaces of electrodes (i.e., roll-pressing, calendaring, transfer stacking, etc.) or by adjusting the average particle sizes of active materials constituting the electrodes. In this embodiment, the pressing method is used.

The cathode active material layer 10 may include a cathode active material, a solid electrolyte, a conductive material, a binder, etc.

The cathode active material may include an oxide active material or a sulfide active material.

The oxide active material may include a rock salt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), or lithium titanate, such as Li₄Ti₅O₁₂.

The sulfide active material may include copper Chevrel, iron sulfide, cobalt sulfide, nickel sulfide or the like.

The solid electrolyte may include an oxide-based solid electrolyte or a sulfide-based solid electrolyte. Preferably, a sulfide-based solid electrolyte having high lithium ion conductivity may be used as the solid electrolyte. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), or Li₁₀GeP₂S₁₂, without being limited to a specific material.

The conductive material may include carbon black, conductive graphite, ethylene black, carbon fiber, graphene or the like.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC) or the like.

The cathode active material layer 10 may include an amount of about 80% to 90% by weight of the cathode active material, an amount of about 5% to 15% by weight of the solid electrolyte, an amount of about 1% to 5% by weight of the conductive material, and an amount of about 1% to 5% by weight of the binder.

The anode active material layer 20 may include an anode active material, a solid electrolyte, a binder, etc.

The anode active material may include, for example, a carbon active material or a metal active material, without being limited to a specific material.

The carbon active material may include mesocarbon microbeads (MCMB), graphite, such as highly oriented pyrolytic graphite (HOPG), or amorphous carbon, such as hard carbon or soft carbon.

The metal active material may include In, Al, Si, Sn, or an alloy including at least one of these elements.

The solid electrolyte may include an oxide-based solid electrolyte or a sulfide-based solid electrolyte. Preferably, a sulfide-based solid electrolyte having high lithium ion conductivity may be used as the solid electrolyte. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), or Li₁₀GeP₂S₁₂, without being limited to a specific material.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC) or the like.

The anode active material layer 20 may include an amount of about 70% to 90% by weight of the anode active material, an amount of about 5% to 25% by weight of the solid electrolyte, and an amount of about 1% to 5% by weight of the binder.

The solid electrolyte layer 30 is interposed between the cathode active material layer 10 and the anode current collector 20, and allows lithium ions to migrate between the cathode active material layer 10 and the anode current collector 20.

The solid electrolyte layer 30 may include an oxide-based solid electrolyte or a sulfide-based solid electrolyte. Preferably, a sulfide-based solid electrolyte having high lithium ion conductivity may be used as the solid electrolyte layer 30. Specifically, a solid electrolyte having lithium ion conductivity of about 0.3 mS/cm or more may be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), or Li₁₀GeP₂S₁₂, without being limited to a specific material.

The thickness of the solid electrolyte layer 30 may be about 30 μm to 70 μm.

The cathode current collector 40 is a base material having electrical conductivity and formed in the shape of a plate, a sheet or a thin film. The cathode current collector 40 may include, for example, aluminum (Al) or stainless steel, such as SUS, without being limited to a specific material.

The thickness of the cathode current collector 40 may be about 6 μm to 12 μm.

The anode current collector 50 is a base material having electrical conductivity and formed in the shape of a plate, a sheet or a thin film. The anode current collector 50 may include, for example, copper (Cu), nickel (Ni) or stainless steel, such as SUS, without being limited to a specific material.

The thickness of the anode current collector 50 may be about 5 μm to 10 μm.

Hereinafter, the present disclosure will be described in more detail through the following examples. The following examples serve merely to exemplarily describe the present disclosure, and are not intended to limit the scope of the disclosure.

### Example 1, Example 2 and Comparative Example 1

An all-solid-state battery having the stack structure shown in FIG. 1 was prepared. The cathode active material layer 10 includes about 83% by weight of a cathode active material, and the anode active material layer 20 includes about 77% by weight of an anode active material. The solid electrolyte layer 30 includes a sulfide-based solid electrolyte having lithium ion conductivity of about 0.9 mS/cm, and has a thickness of about 40 μm. The cathode current collector 40 is an aluminum thin film having a thickness of about 12 μm, and the anode current collector 50 is a copper thin film having a thickness of about 10 μm.

All-solid-state batteries according to Example 1, Example 2 and Comparative Example 1 were manufactured by varying the surface roughnesses of the cathode active material layer 10 and the anode active material layer 20 through the electrode surface pressing method.

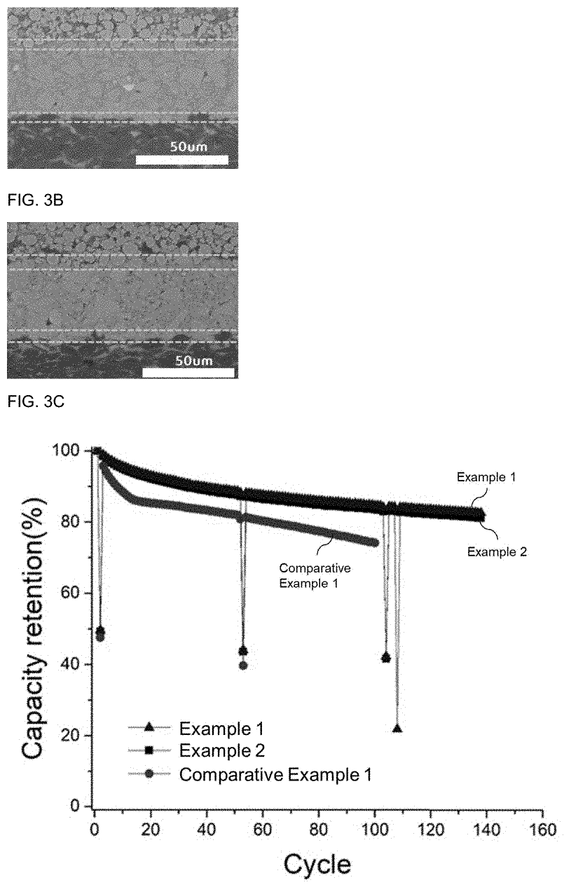

FIG. 3A shows results of measurement of surface roughnesses of the all-solid-state battery according to Example 1. FIG. 3B shows results of measurement of surface roughnesses of the all-solid-state battery according to Example 2. FIG. 3C shows results of measurement of surface roughnesses of the all-solid-state battery according to Comparative Example 1. The cathode active material layer 10, the solid electrolyte layer 30 and the anode active material layer 20 are sequentially provided from the top of each of these figures. After the cross-sections of the respective all-solid-state batteries were analyzed using a scanning electron microscope (SEM), the surface roughness curves of the respective layers of the all-solid-state batteries were derived from results of analysis, and the surface roughnesses of the respective layers were measured using the above-described method. In these figures, respective lines serving as criteria are illustrated.

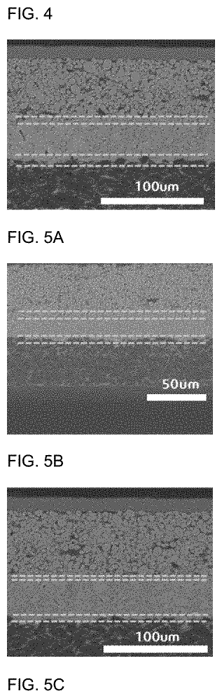

FIG. 4 shows results of measurement of capacity retentions of the all-solid-state batteries according to Example 1, Example 2 and Comparative Example 1. Specifically, the capacity retentions of the all-solid-state batteries were measured by charging and discharging the all-solid-state batteries under conditions of a temperature of about 70° C., a current density of 0.89 mA/cm² (0.3 C), and a voltage of 2.5 V to 4.3 V.

Conditions of the all-solid-state batteries according to Example 1, Example 2 and Comparative Example 1 are set forth in the following Table 1.

TABLE 1

| | | Sum (b₁ + b₂) [μm] of surface | |
|---|---|---|---|
| | | roughness of cathode active | |
| | Current | material layer and surface | |
| | density (a) | roughness of anode active | |
| Category | [mA/cm²] | material layer | Requirement 1 |
| Example 1 | 0.89 | 4 | 4.5 |
| Example 2 | 0.89 | 9 | 10.1 |
| Comp. | 0.89 | 14 | 15.7 |
| Example 1 | | | |

Results of performance evaluation of the respective all-solid-state batteries are set forth in the following Table 2.

TABLE 2

| | | | Capacity retention [%] after |
|---|---|---|---|
| | Initial efficiency | | 100 cycles of charging and |
| Category | [%] | DC-IR [Ω] | discharging |
| Example 1 | 88.6 | 0.295 | 84.6 |
| Example 2 | 88.2 | 0.306 | 83.6 |
| Comp. | 86.4 | 0.426 | 74.1 |
| Example 1 | | | |

Referring to Tables 1 and 2, it may be confirmed that the surface roughnesses of the cathode active material layer 10 and the anode active material layer 20 of the all-solid-state battery according to Comparative Example 1 are excessively great at the low current density of 0.89 mA/cm² (0.3 C), and thus, initial efficiency and capacity retention of the all-solid-state battery are exceedingly low. On the other hand, the all-solid-state batteries according to Example 1 and Example 2 satisfying Requirement 1 exhibit initial efficiency exceeding 88%, and maintain capacity retention exceeding 83% even after 100 cycles of charging and discharging.

### Example 3, Example 4 and Comparative Example 2

An all-solid-state battery having the stack structure shown in FIG. 1 was prepared. The cathode active material layer 10 includes about 83% by weight of a cathode active material, and the anode active material layer 20 includes about 77% by weight of an anode active material. The solid electrolyte layer 30 includes a sulfide-based solid electrolyte having lithium ion conductivity of 0.9 mS/cm, and has a thickness of about 40 μm. The cathode current collector 40 is an aluminum thin film having a thickness of about 12 μm, and the anode current collector 50 is a copper thin film having a thickness of about 10 μm.

All-solid-state batteries according to Example 3, Example 4 and Comparative Example 2 were manufactured by varying the surface roughnesses of the cathode active material layer 10 and the anode active material layer 20 through the electrode surface pressing method.

FIG. 5A shows results of measurement of surface roughnesses of the all-solid-state battery according to Example 3. FIG. 5B shows results of measurement of surface roughnesses of the all-solid-state battery according to Example 3. FIG. 5C shows results of measurement of surface roughnesses of the all-solid-state battery according to Comparative Example 2. The cathode active material layer 10, the solid electrolyte layer 30 and the anode active material layer 20 are sequentially provided from the top of each of these figures. After the cross-sections of the respective all-solid-state batteries were analyzed using a scanning electron microscope (SEM), the surface roughness curves of the respective layers of the all-solid-state batteries were derived from results of analysis, and the surface roughnesses of the respective layers were measured using the above-described method. In these figures, respective lines serving as criteria are illustrated.

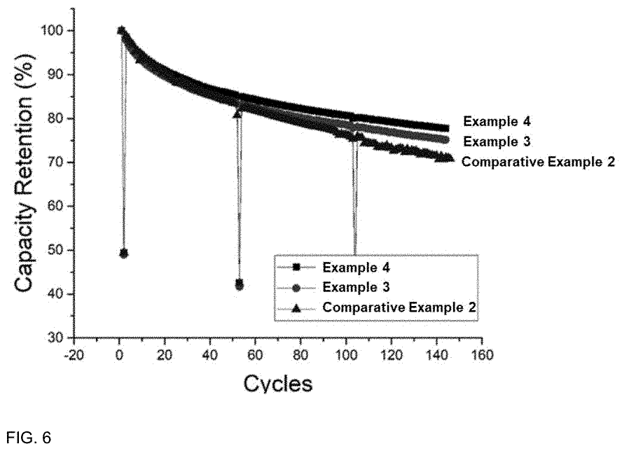

FIG. 6 shows results of measurement of capacity retentions of the all-solid-state batteries according to Example 3, Example 4 and Comparative Example 2. Specifically, the capacity retentions of the all-solid-state batteries were measured by charging and discharging the all-solid-state batteries under conditions of a temperature of about 70° C., a current density of 2.98 mA/cm² (1 C), and a voltage of 2.5 V to 4.3 V.

Conditions of the all-solid-state batteries according to Example 3, Example 4 and Comparative Example 2 are set forth in the following Table 3.

TABLE 3

| | | Sum (b₁ + b₂) [μm] of surface | |
|---|---|---|---|
| | | roughness of cathode active | |
| | Current | material layer and surface | |
| | density (a) | roughness of anode active | |
| Category | [mA/cm²] | material layer | Requirement 1 |
| Comp. | 2.98 | 9 | 3.0 |
| Example 2 | | | |
| Example 3 | 2.98 | 17 | 5.7 |
| Example 4 | 2.98 | 24 | 8.1 |

Results of performance evaluation of the respective all-solid-state batteries are set forth in the following Table 4.

TABLE 4

| | | | Capacity retention [%] after |
|---|---|---|---|
| | Initial efficiency | | 100 cycles of charging and |
| Category | [%] | DC-IR [Ω] | discharging |
| Comp. | 81.4 | 0.406 | 76.2 |
| Example 2 | | | |
| Example 3 | 83.6 | 0.334 | 78.7 |
| Example 4 | 84.4 | 0.325 | 80.5 |

Referring to Tables 3 and 4, it may be confirmed that the surface roughnesses of the cathode active material layer 10 and the anode active material layer 20 of the all-solid-state battery according to Comparative Example 2 are excessively small at the high current density of 2.89 mA/cm² (1 C), and thus, initial efficiency and capacity retention of the all-solid-state battery are low. On the other hand, the all-solid-state batteries according to Example 3 and Example 4 satisfying Requirement 1 exhibit initial efficiency exceeding 83%, and maintain capacity retention exceeding 78% even after 100 cycles of charging and discharging.

As is apparent from the above description, the present disclosure may provide an all-solid-state battery having improved interfacial properties, such as interlayer adhesion, a reaction site, side reaction suppression and reaction uniformity.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. An all-solid-state battery comprising:
a cathode active material layer;
an anode active material layer; and
a solid electrolyte layer interposed between the cathode active material layer and the anode active material layer; and
wherein the all-solid-state battery satisfies Requirement 1 below,
3<(b₁+b₂)/a[10⁻⁴·cm³/mA]<11, [Requirement 1]
wherein a is current density [mA/cm²] of the all-solid-state battery, b₁ is surface roughness [μm] of one side of the cathode active material layer in direction to the solid electrolyte layer, and b₂ is surface roughness [μm] of one side of the anode active material layer in a direction to the solid electrolyte layer.

2. The all-solid-state battery of claim 1, wherein the current density of the all-solid-state battery ranges from about 1 mA/cm² to 5 mA/cm².

3. The all-solid-state battery of claim 1, wherein a ratio of the surface roughness of one side of the cathode active material layer in the direction to the solid electrolyte layer to the surface roughness of one side of the anode active material layer in the direction to the solid electrolyte layer ranges from about 1/3 to 1.

4. The all-solid-state battery of claim 1, wherein the all-solid-state battery satisfies Requirement 2 below,
0.25<b₁/(b₁+b₂)<0.50. [Requirement 2]

5. The all-solid-state battery of claim 1, wherein the all-solid-state battery satisfies Requirement 3 below,
0.50<b₂/(b₁+b₂)<0.75. [Requirement 3]

6. The all-solid-state battery of claim 1, wherein the surface roughness of one side of the cathode active material layer in the direction to the solid electrolyte layer ranges from about 4 μm to 50 μm.

7. The all-solid-state battery of claim 1, wherein the surface roughness of one side of the anode active material layer in the direction to the solid electrolyte layer ranges from about 4 μm to 50 μm.

8. The all-solid-state battery of claim 1, wherein the cathode active material layer comprises an amount of about 80% to 90% by weight of a cathode active material.

9. The all-solid-state battery of claim 1, wherein the anode active material layer comprises an amount of about 70% to 90% by weight of an anode active material.

10. The all-solid-state battery of claim 1, wherein the solid electrolyte layer comprises a sulfide-based solid electrolyte having lithium ion conductivity of about 0.3 mS/cm or more.

11. The all-solid-state battery of claim 1, wherein a thickness of the solid electrolyte layer ranges from about 30 μm to 70 μm.

12. The all-solid-state battery of claim 1, further comprising a cathode current collector disposed on the cathode active material layer,
wherein a thickness of the cathode current collector ranges from about 6 μm to 12 μm.

13. The all-solid-state battery of claim 1, further comprising an anode current collector disposed on the anode active material layer,
wherein a thickness of the anode current collector ranges from about 5 μm to 10 μm.
